(19) United States
(12) Patent Application Publication
(10) Pub. No.: US 2015/0347777 A1
(43) Pub. Date: Dec. 3, 2015

(54) A DATABASE ACCESS SYSTEM AND METHOD FOR A MULTI-TIER COMPUTER ARCHITECTURE

(71) Applicant: MUNBO SOFTWARE PTY LTD, Sydney, New South Wales (AU)

(72) Inventors: Stephen GREGAN, Sydney, New South Wales (AU); Angelo DOUKAS, Sydney, New South Wales (AU)

(21) Appl. No.: 14/653,536

(22) PCT Filed: Dec. 19, 2013
(86) PCT No.: PCT/AU2013/001495

§ 371 Date: Jun. 18, 2015

(30) Foreign Application Priority Data
Dec. 19, 2012 (AU) 2012905566

(51) Int. Cl. G06F 21/62; H04L 29/06; G06F 17/30

(52) U.S. Cl. CPC G06F 21/6218; G06F 17/30595; G06F 17/30339; H04L 63/08

(57) ABSTRACT

A method for assigning access rights in a database server operating in a multi-tier computer architecture comprises granting a database connection user execution rights to execute a gatekeeper function of the database server. The gatekeeper function is executable to extract session related data and request data from an XML database request message provided by the database convection user. The gatekeeper function is further executable to execute an authentication function for authenticating the session related data. An owner of the authentication function is granted rights to call one or more stored procedures identified by the session related data, responsive to the session related data being successfully authenticated.

### FIELD OF THE INVENTION

The present invention relates generally to database access techniques for a multi-tier architecture and more specifically to systems and methods for validating/authenticating database access requests for preventing fraudulent database transactions.

### BACKGROUND OF THE INVENTION

The development of three-tiered architectures has led directly to the creation and rapid expansion of the Internet. Given the requirement for web servers to be accessible to the public and for standard browsers to be used at the presentation layer, however, three-tiered architectures have also dramatically increased an organisation's exposure to fraud and unauthorised access.

Developers of three-tiered applications are essentially caught between two objectives that are mutually incompatible: the desire to make an application as open and as accessible as possible and the desire to make it as secure as possible. Some elements of a three-tiered architecture (such as the requirement for a web server and a standard browser) are outside the developer's control. Other elements are not. The most important of these is whether the business logic (i.e. the part of the application program code that interacts with the data base) is located in the middle layer or the database layer of the multi-tiered architecture.

In a typical three-tiered implementation, the business logic resides exclusively in the middle layer and is both invoked and executed in this layer using a scripting language. Consequently, SQL commands (i.e. select, insert, delete, update) are issued to the database directly from this layer. Within the middle layer, the retrieved data is manipulated and the new web page is assembled in HTML and JavaScript and sent to the client browser for display. While locating the business logic in the middle layer does allow for database independence and simplicity of development and deployment (thus satisfying the “open and accessible” requirement), such an implementation can expose the data tables to unauthorised access at the presentation layer.

One common technique used by hackers/fraudsters to gain access to data in such a three-tier implementation is through SQL injection. Very often, data keyed by a user (e.g. customer number) becomes part of the SQL command itself. Depending on how much care the developer has taken to prevent this from occurring, a hacker could enter a simple SQL command (e.g. a customer number) that “injects” itself into the SQL command in the middle layer. The total visibility of the HTML and JavaScript code within the browser, which is outside the control of the developer, greatly assists the hacker in achieving their objective. Many sites are exposed in this way and make easy pickings for hackers who do not need to go to the trouble of hacking into the web server itself (although this is also possible, as will be described in more detail below). An even greater level of exposure occurs when a developer includes part of the SQL command in the URL itself, as will be understood by persons skilled in the art.

The more secure form of three-tier implementation (which also offers better performance and maintenance) is to locate the business logic within stored procedures inside the database on the database server. The stored procedures are invoked by scripts in the middle layer, using parameters or “programming interfaces”, but the stored procedures themselves execute in the database layer. As persons skilled in the art will appreciate, such implementations are typically configured such that a database connection user only has rights to execute the stored procedures, thereby protecting the data tables (i.e. the data itself) from being directly accessed by the database connection user.

However, if the hacker is able to successfully break into the web server and locate the relevant user ID and password for the common database connection user (which must unavoidably be stored on the web server), they are still able to invoke the stored procedures. Once inside the web server, a hacker's ability to cause damage is greatly aided by the requirement of three-tier architectures to use scripting languages rather than compiled code for invoking stored procedures (ASPs and JSPs, by their very nature, are designed to provide dynamic content to HTML websites). Thus, by viewing the scripts used to call the stored procedures (and the data being provided by the client for implementing the stored procedures) the hacker may be able to work out the associations between the script and the business logic being invoked. Once armed with this understanding, a hacker can invoke selected business logic to their advantage. Using an online banking scenario as an example, if the hacker is able to hack into the banking web server and determine what script is operable to invoke the stored procedure for transferring money from one account to another, the hacker could simply insert the desired account numbers into the programming interface when invoking the stored procedure.

Furthermore, implementations which use stored procedures will in many instances still have some amount of business logic residing in the middle layer (and thus present a potential for hacker attack). For example, if the data requested from the presentation layer involves a list, the stored procedure would typically return each unit of data to the ASP or JSP (implemented by the web server), which then creates the list and encapsulates it within HTML code returned to the presentation layer.

Evidently, a three-tiered implementation which locates business logic in the database server offers a greater level of security than an implementation having the business logic located it in the middle layer. There is still ample opportunity, however, for a hacker to create havoc in both implementations.

### SUMMARY OF THE INVENTION

In accordance with a first aspect of the present invention there is provided a method for assigning access rights in a database server implementing a database, the method comprising:
granting a database connection user execution rights to execute a gatekeeper function of the database server, the gatekeeper function in turn being operable to:
   extract session related data and request data from an XML database request message provided by the database connection user; and
   execute an authentication function for authenticating the session related data; and
granting an owner of the authentication function rights to execute stored procedures stored in the database, such that, responsive to the session data being successfully authenticated, the authentication function is executable to execute one or more of the stored procedures identified by the session related data.

In an embodiment the method further comprises granting an owner of the stored procedures access rights to data tables stored by the database for completing the data request.

In an embodiment the XML request message is generated by an XML-based presentation interface and subsequently routed to the database server by way of a web server.

In an embodiment the XML request message is generated by a web server based on data provided by a non XML-based presentation interface.

In an embodiment the web server connects to the database server as the database connection user.

In accordance with a second aspect of the present invention there is provided a method for accessing a database server implementing a database in a multi-tier computer architecture, the method comprising:
receiving an XML message associated with a database request from a database connection user, the XML message including session related data and request data;
responsive to receiving the XML message, granting the database connection user execution rights to execute a gatekeeper function of the database server, the gatekeeper function being executable to:
   extract the session related data and request data from the XML message; and
   execute an authentication function of the database server for authenticating the session related data; and
responsive to the session related data being successfully authenticated by the authentication function, granting an owner of the authentication function rights to stored procedures that can be executed by the authentication function for completing the database request.

In an embodiment the stored procedures called by the authentication function being identifiable from the session related data.

In an embodiment the XML message is generated by an XML-based presentation interface and routed to the database server via a web server.

In an embodiment the XML message is generated by a compiled program implemented by the presentation interface.

In an embodiment the session related data is generated, at least in part, through implementation of an XML stylesheet by the XML-based presentation interface.

In an embodiment the XML request message is generated by a web server based on data provided by a non XML-based presentation interface.

In an embodiment the web server connects to the database server as the database connection user.

In an embodiment at least the session related data of the XML message is encrypted.

In an embodiment the method further comprises granting an owner of the stored procedures access rights to data tables implemented by the database, responsive to the stored procedure being called by the authentication function.

In an embodiment the session related data comprises at least one of a unique identifier for the requesting party and a session identifier.

In an embodiment the session related data includes business logic execution data which is evaluated by the authentication function to determine whether the requesting party has rights to the requested stored procedures.

In an embodiment the business logic execution data comprises a non-descriptive code which is evaluated by the authentication function to determine which stored procedures to call.

In an embodiment the session related data comprises a one-time code, the one-time code having been generated by the authentication function responsive to successfully authenticating a previous database request.

In an embodiment the method further comprises implementing a call-back function to supply the extracted request data to the stored procedures.

In an embodiment the method further comprises implementing the call-back function to pass the data output from the stored procedures to the gatekeeper function for assembling an XML response message.

In accordance with a third aspect of the present invention there is provided a database server operable in a multi-tier architecture and comprising a processor operable to implement:
a gatekeeper function for receiving an XML message including session related data and request data, the gatekeeper function executable by a database connection user to:
   extract the session related data and request data from the XML message; and
   execute an authentication function of the database server for authenticating the session related data; and
a database storing one or more stored procedures, an owner of the stored procedures granting an owner of the authentication function rights to call one or more of the stored procedures responsive to the session related data being successfully authenticated by the authentication function.

In accordance with a fourth aspect of the present invention there is provided a web server operable in a multi-tier architecture and comprising a processor operable to implement:
an application script function for communicating with a non-XML based presentation interface for receiving a database request message including request data;
gatekeeper function operable to communicate with the application script function for combining the request data with session related data in an XML message for communicating to a database server in accordance with the third aspect.

In accordance with a fifth aspect there is provided a method of implementing a secure database access scheme for a database server, comprising:
implementing a gatekeeper function which is the sole function executable by a common database connection user attempting to call one or more stored procedures implemented by the database server based on data extracted from a database request message, the gatekeeper function being executable to call on one or more other database functions which are authorised to access the stored procedures.

In an embodiment the method further comprises authorising the one or more other functions after having successfully authenticated session related data extracted from the database request message.

In an embodiment the method further comprises implementing the scheme such that the one or more other functions are granted access rights to the stored procedure by a different database user implemented by the database server.

In the context of the present specification the term ‘web browser’ or ‘browser interface’ or ‘smart client’ are used to refer to any presentation interface that is capable of communicating with a server for viewing data on a client computer terminal.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic of a three-tier web architecture in accordance with an embodiment of the present invention;

FIG. 2 is a schematic illustrating associations between security objects, function objects and business objects;

FIG. 3 is a schematic illustrating an example function/business object hierarchy, in accordance with an embodiment;

FIGS. 4 and 5 are schematics illustrating flow of a database request message, in accordance with an embodiment; and

FIG. 6 is a schematic illustrating an embodiment integrated into a conventional three-tier architecture.

### DETAILED DESCRIPTION OF PREFERRED EMBODIMENTS

For the purposes of illustration, and with reference to the figures, embodiments of the invention will hereafter be described in the context of an architecture for providing multi-tier applications accessible by way of a presentation interface which is loaded on a standard general purpose computer (hereafter ‘client terminal’).

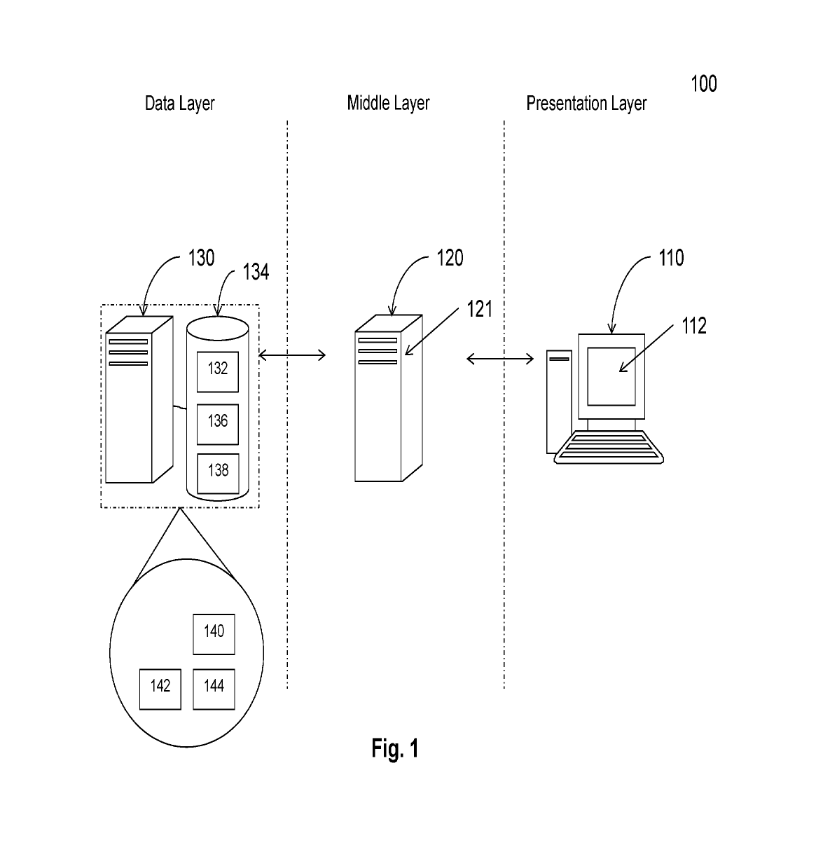

According to the embodiment illustrated in FIGS. 1 to 5, the presentation interface is in the form of an XML-based presentation interface that is configured to execute XML stylesheets for orchestrating communication between the various components/layers of the multi-tiered architecture, including the ability to generate XML request messages for accessing the database. Thus, the XML stylesheets are effectively used a replacement for conventional program logic to allow the presentation layer and the database logic layer to communicate via XML messaging. Such an XML based presentation interface and methodology for generating database access requests in described in co-pending PCT application PCT/AU2013/000573 (to the same applicant), the contents of which are incorporated herein by reference.

### General System Configuration

With reference to FIG. 1, there is shown an example three-tiered computing architecture 100 according to an embodiment of the present invention. Specifically, a first tier or ‘presentation layer’ of the architecture 100 comprises the client terminal 110 which operates the XML-based presentation interface 112.

As mentioned above, the XML-based presentation interface 112 (in this case a compiled program) is operable to implement one or more XML stylesheets for facilitating XML messaging between different logic layers of the three-tier architecture 100 associated with data requests or operations involving stored data items.

More specifically, the XML stylesheets include logic which recognises data requests issued by the presentation interface (e.g. a request, generated responsive to a user interaction with a rendered page, for access to data stored within a database table on a database server). In response to recognising a request for data, the implemented XML stylesheet causes the presentation interface 112 to send an XML database request message to the database 130, such as a request to call a particular stored procedure (i.e. to return the requested data to the presentation interface 112, as will be described in more detail below).

A middle-tier server 120 (hereafter referred to as a “web server”) is situated in the second or ‘middle’ tier and is operable to process and route database request messages to the database server 130. Correspondingly, the middle-tier server 120 routes XML server response messages (containing requested data in XML) back to the presentation interface 112. In this sense, the web server 120 effectively operates as a “handler” for routing of the XML messages.

As will be understood by persons skilled in the art, the web server 120 connects to the database server 130 as a common database connection user (according to the illustrated embodiment referred to as “Connection User”), which is utilised for all access requests placed with the database. The use of a common database connection user allows the web server to handle simultaneous connections with the database server 130 being instructed from many different requesting parties.

The processing and connectivity functions discussed above are handled by a database client component 121 (which may comprise of software, hardware or a combination of the two), which is implemented by the web server 120. The database client component 121 allows interaction with the database 134 from various client platforms (e.g. Linux, Windows, Mac, etc.) on which the web server 120 may be installed.

The database server 130 is positioned in the third tier (‘database layer’) and is operable to receive connection requests from the common database connection user (i.e. web server 120). As previously mentioned, the database server 130 implements a database 134 storing business logic (in the form of stored procedures 132) which is used to access application data tables 136 (also stored in the database 134) for completing a database request. A set of security tables 138 storing session and authentication data is also stored in the database 134 and are accessible by a authentication function for persistently authenticating each new database request message placed with the database server 130, as will be described in more detail in subsequent paragraphs. Illustratively, the database 134 is an Oracle Server database which is capable of executing stored procedures (e.g. PL/SQL or Java) for accessing the database.

The database server 130 includes a processor arranged to implement a number of functions/modules that are executable for processing incoming database request messages, as will be described in more detail below. According to the illustrated embodiment, the executable functions include a gatekeeper function 140, authentication function 142 and call-back function 144. It will be understood that the functions/modules 140, 142, 144 may be implemented as software, hardware or a combination of the two.

### Execution Objects

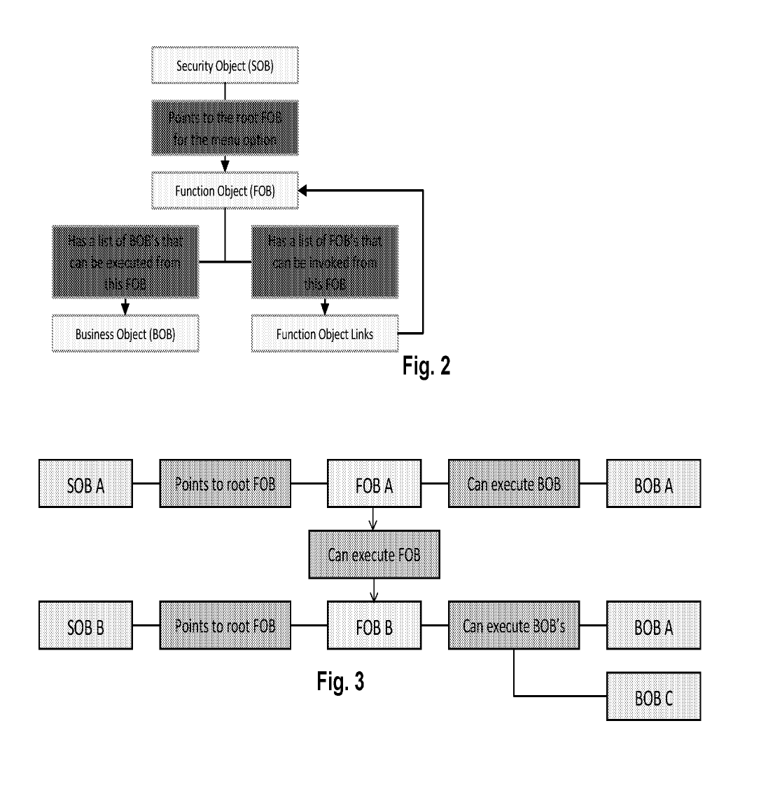

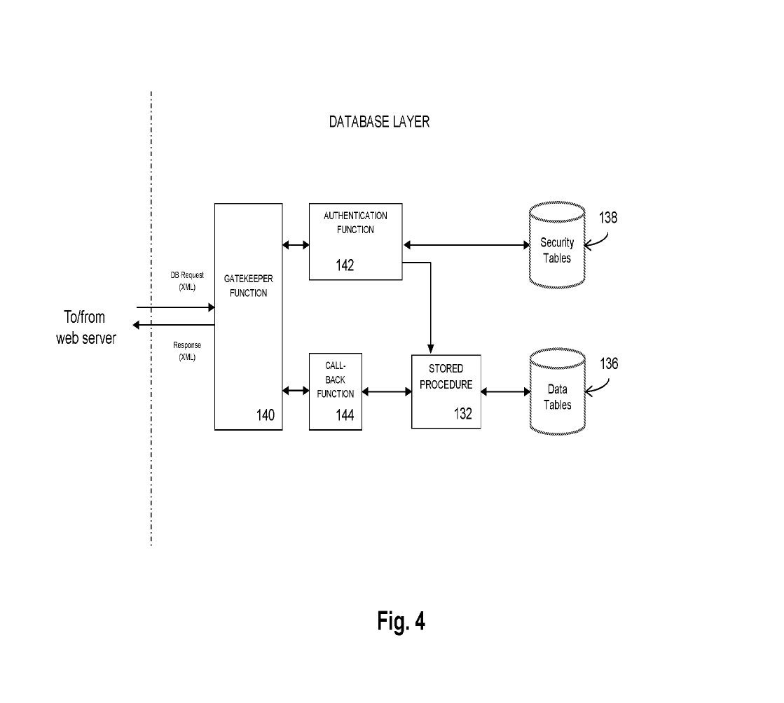

The presentation interface 112 is operable to recognise and process business logic execution data (hereafter execution data) through implementation of a stylesheet. The execution data is associated with user requested functionality that requires access to the data tables 136. Hereafter the execution data is expressed in terms of different execution “objects” (which can be regarded as separate logical entities) which are communicated to the database server 130 in the XML message for validation by the authentication function 142. According to the presently described embodiment, there are three different types of execution object as will now be described in more detail with reference to FIGS. 2 and 3.

Business Object (hereafter “BOB”)—This type of object is executable to call a stored procedure of the hosted application for implementing some desired business logic and database activity. For security reasons, each BOB is represented as a non-descriptive code, so the actual stored procedure name that it is executable to call is not identifiable should the XML request message be intercepted by a hacker.

Function Object (hereafter “FOB”)—This type of object points to a particular XML stylesheet that is executable by the presentation interface 112 for completing the requested functionality (i.e. to implement the presentation visuals and send the relevant BOB in a database request message to the database 130). Each FOB is also capable of invoking one or more other FOBs, as shown in FIG. 2.

Security Object (hereafter “SOB”)—Each hierarchical FOB structure is associated with a security object (SOB) that points to a corresponding root FOB. The SOB, in combination with the FOB, can advantageously be utilised for setting user access rights to the business logic implemented by the database 130. According to embodiments described herein, each user is assigned a particular security role (stored in the security tables 138) that dictates what SOBs they are authorised to access. For example, a first user may be designated security role “A” which allows access only to basic functionality for an application (e.g. retrieving customer records), while another user may be designated security role “B” which allows access to all functionality provided by the application (e.g. creating, modifying, or deleting customer records). In addition to storing and evaluating SOBs for determining valid user functions, the system is also operable to store valid FOB and SOB hierarchies that may also be evaluated by the authentication function 142 when validating a database request. An example hierarchy is shown in FIG. 3. According to the illustrated example, the hierarchy starting with FOB A is able to validly execute BOB A as well as execute FOB B. A hierarchy starting with FOB B on the other hand, can validly execute BOB A and BOB C, but is unable to execute FOB A. This example also demonstrates how various function objects can be re-used within the architecture described herein.

### Session Creation

A new session is created every time a user connects to a database installation with a unique user identifier. New sessions are created only after a user has first been successfully authenticated by the database server 130 for that connection. In a particular embodiment, the authentication step involves the user supplying a user identifier and password to the authentication function 142 of the database server 130 (i.e. via an encrypted XML message). The authentication function 142 subsequently inspects the tables 138 to determine whether the supplied information matches valid authentication information for that user (i.e. provided by the user during enrolment with the system). If so, the user is deemed to have successfully authenticated themselves, responsive to which a unique session is created for that connection. Session data including a unique session identifier, user identifier and contact timestamp is stored in the tables 138 for subsequent session validation. The unique session identifier is returned to the user in an encrypted session response message. The unique session identifier allows the requestor to persist the user session on subsequent interactions with the database server 130, as will be described below.

### Database Security

Embodiments described herein assign different access privileges to different database schemas (represented hereafter as “database users” within the database) for implementing the afore-described database functions 140, 142, 144. As will become evident from subsequent paragraphs, such an assignment of access privileges serves to provide a first layer of defence for protecting both the data stored in the database tables, as well as the stored procedures.

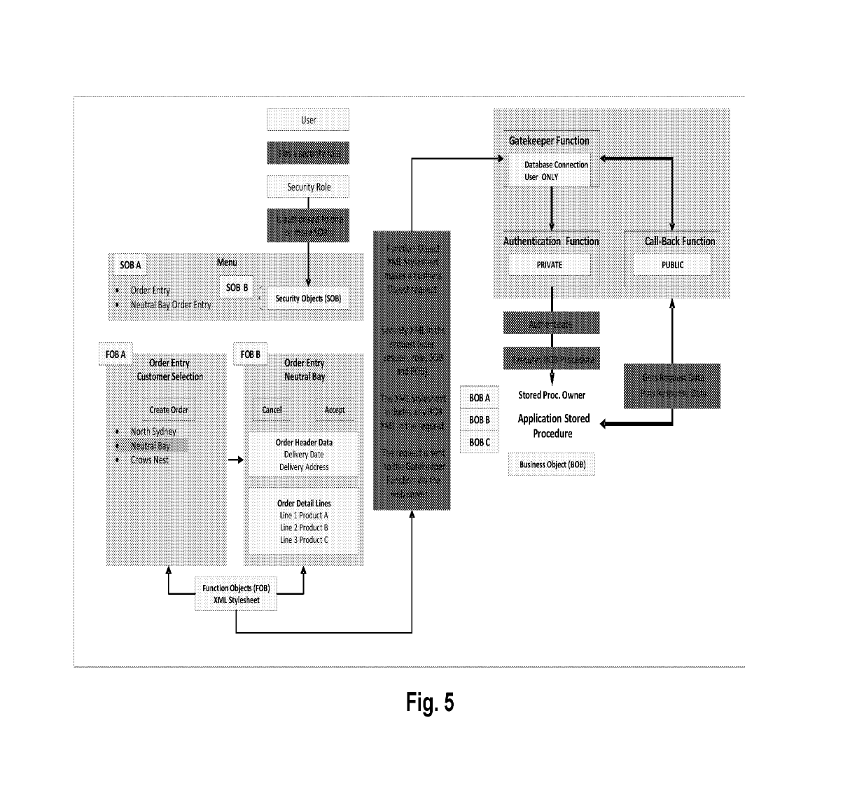

According to the embodiment shown in FIG. 4, the installation comprises three database users, as follows:
Database Connection User—this database user is called on to access the database server 130 from the web server 120 and only has rights to execute a gatekeeper function 140 owned by the Persistent Session User (see below).
Security Table Owner—this database user is the owner of the security tables 138 and only grants table access rights to Persistent Session User.
Persistent Session User—this database user is the owner of the gatekeeper function 140, authentication function 142 and call back function 144. As mentioned above, the Persistent Session User grants the Database Connection User rights to only execute the gatekeeper function 140 (i.e. and not any of the other functions/stored procedures implemented on the database server), which in turn may call on the authentication function 142 and call back function 144 as required.

As can be seen from FIG. 4, the gatekeeper function 140 is the sole entry point to the database server 130 and does not have any direct access privileges to the stored procedures 132 or data tables 136. Instead, the gatekeeper function 140 is executable to:
process the incoming XML message to extract the request data (i.e. for supplying to the stored procedures to complete a database request), as well as the necessary business logic execution data and session related security data for authentication/validation by the authentication function 142; and
assembling the XML database response message being returned to the presentation interface 112 via web server 120.

Thus, it will be understood that since the database connection user is only granted rights to execute the gatekeeper function 140, the database connection user does not have any direct access to the stored procedures 132 or data tables 136, thereby providing a first formidable barrier of entry to the database server 130.

It will be understood that any particular naming convention could be assigned to the different schemas/users.

Embodiments are also operable to provide a second form of database protection, by way of a persistent authentication process whereby each new database request within a session message that is placed with the database server 130 is validated prior to performing the requested database activity. As will be evident from the below description, persistent authentication advantageously allows administrators to instantaneously change individual (or all) user rights to selected database functionality at any time. For example, embodiments may allow for inactivating a user, database function, language or a combination of the same in real time (i.e. even while a session is still deemed to be ‘valid’ and not expired).

The first step in the persistent authentication process involves generating session security data, for packaging with each database request message (i.e. in association with the request data and execution data) to be sent to the database server 130. The session security data comprises the session identifier (previously communicated to the user responsive to a successful authentication), installation address (in the present case being a URL pointing to the web server 120, which is in turn communicable with the relevant database server hosting the installation) and a user identifier.

Embodiments of the present invention can be extended to additionally handle database request messages placed from a conventional HTML-based presentation interface (described in more detail in subsequent paragraphs) and in this regard the session security data may further specify whether the request was placed from an XML-based presentation interface 112 or a conventional HTML-based interface (which allows for the response served back to the interface to be handled appropriately by the web server 120, again, as will be described in more detail in subsequent paragraphs). Furthermore, the presentation interface 112 may be configured to operate with different spoken languages and in this case the security data would also identify the originating language. Thus, the session security data may comprise the following:
Session Identifier
Installation
User Identifier
Presentation Type
Language

For each database request message received by the database server 130, the gatekeeper function 140 (executable by the database connection user) extracts the session security data and execution data (hereafter collectively referred to as “session related data”) and passes it to the authentication function 142, which it is in turn authorised to execute. The gatekeeper function 140 also extracts the request data for communicating to the call-back function 144 for reasons which will become evident.

In an initial processing stage, the authentication function 140 inspects the session tables 138 for validating the session identifier provided in the extracted session security data and ensures that the current session is still active (i.e. based on any predefined timeout settings).

If valid and still active (i.e. not expired), the authentication function 142 then proceeds to a second stage which involves additionally evaluating the execution data for determining whether the user has rights to the requested database functionality. In more detail this involves evaluating the:
Role
SOB
FOB
BOB

### Example

An example process flow according to an embodiment of the invention will now be described with reference to FIG. 5. According to the illustrated example, a user is accessing the database 130 to place a grocery order with a supermarket. The user is designated a security role that allows them access to both SOB A and SOB B, where SOB A points to a FOB/BOB hierarchy for supermarket selection and SOB points to a FOB/BOB hierarchy for selecting groceries available from a specific supermarket.

At steps S1 to S4, the user accesses a menu on the presentation interface 112 for creating a supermarket order. The corresponding stylesheet(s) is/are served to the presentation interface 112 for receiving the user selection. In this case, a first stylesheet (corresponding to root function object A) is initially executed by the presentation interface 112 for implementing the presentation visuals and logic for allowing the user to select a supermarket store for ordering the groceries. As part of this process, the stylesheet is executable to place a database request with the database 130 for retrieving a list of supermarket stores (stored in the data tables 136) that are able to receive remote customer orders.

As can be seen from the FIG. 4, the database request message is included in an encoded XML stream routed to the database 130 by way of the web server 120 (which subsequently connects to the database 130 as the database connection user, as previously described). The encoded XML stream includes the relevant session security XML data, business logic execution data and request data for persistent authentication and completion of the database request.

Responsive to receiving the request, the gatekeeper function 140 is executable by the database connection user to extract the relevant session security and execution data which it passes to the authentication function 142 for validation, as previously described.

Returning to FIG. 5, responsive to the authentication function 142 validating the session security and execution data, the authentication function 142 determines the relevant stored procedure to call (i.e. from an evaluation of the BOB code included in the execution data). The authentication function 142 then calls the relevant stored procedure, which is subsequently invoked for retrieving names of supermarkets that are registered for remote ordering from the data tables 136. In more detail, the process of retrieving the supermarket names involves invoking the call back function 144 to supply (via get methods, as are well understood in the art) the extracted XML request data to the stored procedures 132. Correspondingly, the call back function 144 implements put methods for accepting resultant data which is communicated to the gatekeeper function 140 for XML message assembly. In this manner it can be seen that the XML message assembly configuration allows for a response to be sent back to the web server 120, and in turn the presentation interface 112, as a single XML message. Thus, embodiments advantageously eliminate the need to have any business logic in the web server 120 for message construction, in turn improving the security and performance of the implementation.

Thus, it can be seen that, through implementation of the various aforementioned database server functions (and associated privileges), both the stored procedures and data tables are completely isolated from outside access. Further, by placing the information required to execute a stored procedure inside an encrypted XML message, embodiments eliminate the ability of a hacker to call a stored procedure directly from the web server 120 even if the name of the stored procedure, and its associated programming interfaces, were known by the hacker.

As previously described, embodiments of the invention are also capable of being integrated with a more conventional form of three-tiered architecture, whereby the client presentation interface is a non-XML based presentation interface (e.g. a standard HTML-based browser such as Internet Explorer, a smart client, or the like). Such implementations will hereafter be referred to as “custom implementations”. The web server may, for example, be a Microsoft IIS web server running ASP, Visual Basic Script and Visual Basic.

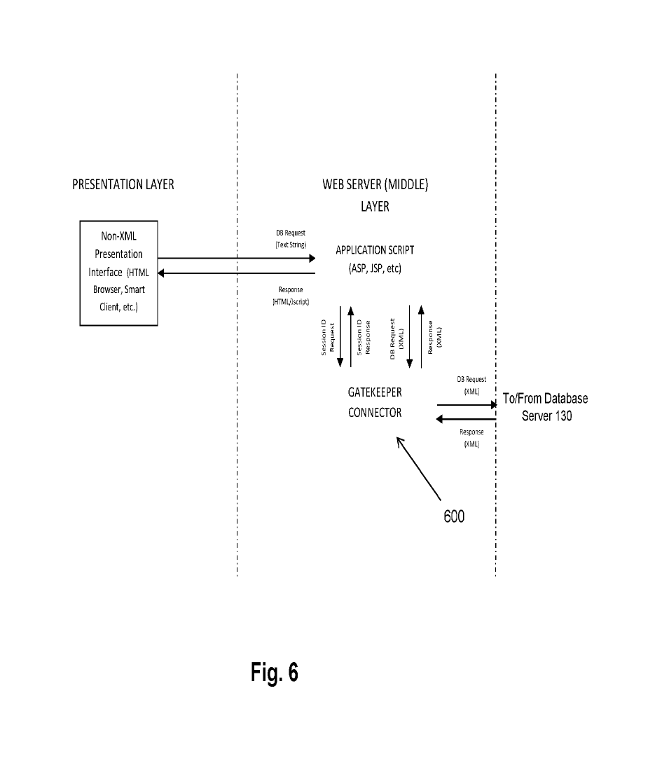

More specifically, and with additional reference to FIG. 6, in addition to the standard web server handlers that are applicable for processing the HTTP requests (e.g. ASP), embodiments described herein additionally comprise a gatekeeper connector function 602 which is communicable with the standard handler to interact with the database server, using the same XML messaging protocol as afore-described. Indeed, the remainder of the communication with the database server (post output from the web connector function) is identical to the XML-based implementation described in preceding embodiments. The gatekeeper connector 602 implements a dynamic link library as will now be described.

As previously described for the XML-based presentation interface, embodiments rely on the creation and provision of execution data and session security data (together with the relevant request data) to the database server 130 for completing database requests. Therefore, a function object request from an XML stylesheet requires an initial FOB authentication request that both authenticates the session's rights to execute the FOB and returns the relevant XML stylesheet to the presentation interface for loading. In a particular embodiment, a similar mechanism for locating the actual stylesheet implementation file could be utilised for the custom implementation. As an alternative, the non-XML based browser of the custom installation may simply URL to the implementation file (i.e. directly from the presentation interface), thus avoiding the FOB authentication step. This would not compromise the security as the FOB authentication is also performed on all BOB execution requests.

In a particular embodiment, the web connector dynamic link library provides the following functionality:
create a session (for a single application only).
extend a session.
destroy a session.
retrieve session application role information (the menu structure for the session).
authenticate a session application function object.
authenticate and execute a session application business object.

By way of example, the steps performed by the custom implementation for authenticating a user in accordance with a particular embodiment comprise the following:

1. Non-xml based browser sends request for an ASP script that is used to authenticate a user.
2. The ASP script creates an instance of the gatekeeper connector.
3. The ASP script calls a gatekeeper connector create session function which passes the user, password, application, presentation and language.
4. The gatekeeper connector authenticates the user and the user's right to access the application and returns a unique session identifier.
5. The ASP script calls the gatekeeper connector role retrieval function passing the unique session identifier.
6. The gatekeeper connector retrieves the users' security menu information based on the session identifier and returns the security menu data via an XML structure. The security menu data contains all the execution data (SOB, FOB) to which the session user is authorised.
7. The ASP script generates the HTML and JavaScript response required to present the users security.
8. The ASP script is subsequently responsible for persisting the session identifier for subsequent requests.

An example embodiment for executing a business object utilising the custom implementation comprises:

1. Browser sends request for an ASP script that is used to implement database functionality.
2. The ASP script creates an instance of the gatekeeper connector.
3. The ASP script calls the gatekeeper connector execute BOB function passing the user, session, application, presentation, language, SOB, FOB, BOB and the BOB XML request data
4. The gatekeeper connector persists the session and authenticates the user's right to execute the business object. The business object is executed and the BOB response XML returned.
5. The ASP script generates the HTML and JavaScript response using the BOB response XML.

### Session Extension

As previously discussed, embodiments advantageously allow users to extend their session when it has timed out without any loss of data. As persons skilled in the art will understand, the session ID is utilised in conventional HTML based implementations to remember certain session related information during a particular session (which may not necessarily appear on a user's screen). The session ID is allocated by the web server at the beginning of a session and delivered to the presentation layer by a cookie (a string of data), and then passed between the presentation and web server layers in subsequent database requests. Thus, in such conventional HTML based implementation since the session ID is managed by the web server, and timed out by the web server, it never reaches the database layer where the user ID and password reside. As such, it is not possible to extend a session once the session has expired or timed out.

In contrast to such conventional implementations, embodiments described herein store the session ID within the database layer itself (i.e. for use during the persistent authentication, as previously described). Thus, according to particular embodiments, a user may be allowed to extent a timed out session by simply re-entering their password for the current user ID without any loss of data since the session ID (i.e. used to store the off-screen session data needed to persist the session) is known by the database and thus still accessible for persistent/extending the session.

### One Time Session Codes

To further enhance the security of the system, embodiments may further utilise one time passcodes for new requests placed with the database server 130. More specifically, a one-time passcode (e.g. a unique request identifier) may be automatically generated by the authentication function 142 and sent to the presentation interface 112 after each valid session request. The request identifier is then packaged with a subsequent XML database request placed with the database server 130 (i.e. as part of the session security data), for evaluation by the authentication function 142 during the persistent authentication process. This may involve inspecting a table storing valid and non-used request IDs previously generated by the authentication function). In this manner, even if a hacker were to intercept the request message and manage to decrypt the session security data, such data will only be valid for the current request (and thus any attempts by the hacker to fraudulently access the database using this data in a subsequent request will not be accepted by the authentication function). If a hacker were to trap the database response with the new request ID, they would need to decrypt the response, get the request ID, and make a malicious request all before the next request is placed from the real user (or the user closes the session). Even if the hacker managed to achieve all this then they would only be able to make malicious requests until the real user made a subsequent request (i.e. since the request ID would no longer be deemed valid by the authentication function). The authentication function 142 could thus immediately invalidate the session.

### Further Detail of System Configuration

It will be understood that the web server 120 and database server 130 include typical server hardware including a processor, motherboard, memory, hard disk and a power supply. The servers 120, 130 also include an operating system which co-operates with the hardware to provide an environment in which software applications can be executed. In this regard, the hard disk of the servers are loaded with software which, under the control of the processor, is operable to implement the various message and stylesheet processing functions as previously described.

It will be appreciated that the client computer on which the presentation interface 112 is installed could be any suitable form of network-enabled computing device that is capable of implementing a browser interface. For example, the computing device may be a general purpose computer or a special purpose device including a smart phone, tablet, or the like. Details of such devices (e.g. processor, memory, display, data storage, etc.) are omitted for the sake of clarity. Where the special purpose device is a smart client device such as a mobile phone, an application may be downloaded by the device for generating and receiving the XML BOB request/response messages (as afore-described). Further, it will be understood that the connection to the network by the smart client device may be by way of an intermediate network (e.g. mobile phone gateway).

Embodiments described herein can be seen to exhibit at least one of the following advantages:
A protocol and platform that protect both the data and stored procedures by way of isolated execution and access privileges and functions within the database server and messaging protocols
The ability to locate all business logic, without exception, securely within the database server
Enhanced message security by way of encrypted XML messaging utilised for all communications between the web server and database server.
Presentation interface independence, allowing the system to be utilised for both XML based and non-XML based browsers.
Persistent authentication of all database requests placed with the database server, allowing immediate and dynamic adjustment of database request privileges for any and all individuals accessing the database.
The ability to immediately extend a session when a session has timed out without losing in data entered in to the system in the intervening period. Session extension is very relevant for the message based invocation model. If a session can be easily extended without loss of data, organisations can reduce the session time-out interval without creating annoyance with users and, in so doing, will have reduced the maximum amount of time available for a hacker to intercept and issue a database request.

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for assigning access rights in a database server implementing a database, the method comprising:
granting a database connection user execution rights to execute a gatekeeper function of the database server, the gatekeeper function in turn being operable to:
extract session related data and request data from an XML database request message provided by the database connection user; and
execute an authentication function for
authenticating the session related data; and
granting an owner of the authentication function rights to execute one or more stored procedures identified by the session related data responsive to the session data being successfully authenticated.

2. A method in accordance with claim 1, further
comprising granting an owner of the stored procedures access rights to data tables stored by the database for completing the data request.

3. A method in accordance with claim 1, wherein the XML request message is generated by an XML-based
presentation interface and subsequently routed to the database server by way of a web server.

4. A method in accordance with claim 1, wherein the XML request message is generated by a web server based on data provided by a non XML-based presentation interface.

5. A method in accordance with claim 3, wherein the web server connects to the database server as the database connection user.

6. A method for accessing a database server implementing a database in a multi-tier computer architecture, the method comprising:
receiving an XML message associated with a database request from a database connection user, the XML message including session related data and request data;
responsive to receiving the XML message, granting the database connection user execution rights to execute a gatekeeper function of the database server, the gatekeeper function being executable to:
extract the session related data and request data from the XML message; and
execute an authentication function of the database server for
authenticating the session related data; and
responsive to the session related data being
successfully authenticated by the authentication function, granting an owner of the authentication function rights to stored procedures that can be executed for completing the database request.

7. A method in accordance with claim 6, wherein the stored procedures called by the authentication function are identifiable from the session related data.

8. A method in accordance with claim 6, wherein the XML message is generated by an XML-based presentation interface and routed to the database server via a web server.

9. A method in accordance with claim 8, wherein the XML message is generated by a compiled program implemented by the presentation interface.

10. A method in accordance with claim 8; wherein the session related data is generated, at least in part, through implementation of an XML stylesheet by the XML-based presentation interface.

11. A method in accordance with claim 6, wherein the XML request message is generated by a web server based on data provided by a non XML-based presentation interface.

12. A method in accordance with claim 8, wherein the web server connects to the database server as the database connection user.

13. A method in accordance with claim 6, wherein at least the session related data of the XML message is encrypted.

14. A method in accordance with claim 6, further comprising granting an owner of the stored
procedures access rights to data tables implemented by the database, responsive to the stored procedure being called by the authentication function.

15. A method in accordance with claim 6, wherein the session related data comprises at least one of a unique identifier for the requesting party and a session identifier.

16. A method in accordance with claim 6, wherein the session related data includes business logic execution data which is evaluated by the authentication function to determine whether the requesting party has rights to the requested stored procedures.

17. A method in accordance with claim 16, wherein the business logic execution data comprises a non-descriptive code which is evaluated by the authentication function to determine which stored procedures to call.

18. A method in accordance with claim 6, wherein the session related data comprises a one-time code, the one-time code having been generated by the authentication function responsive to successfully authenticating a previous database request.

19. A method in accordance with claim 6, further comprising implementing a call-back function to supply the extracted request data to the stored procedures.

20. A method in accordance with claim 19, further
comprising implementing the call-back function to pass the data output from the stored procedures to the gatekeeper function for assembling an XML response message.

21. A database server operable in a multi-tier
architecture and comprising a processor operable to
implement:
a gatekeeper function for receiving an XML message including session related data and request data, the gatekeeper function executable by a database connection user to:
extract the session related data and request data from the XML message; and
execute an authentication function of the database server for authenticating the session related data; and
a database storing one or more stored procedures, an owner of the stored procedures granting an owner of the authentication function rights to call one or more of the stored procedures responsive to the session related data being successfully authenticated by the authentication function.

22-25. (canceled)
